(19) United States
(12) Patent Application Publication
(10) Pub. No.: US 2014/0195503 A1
(43) Pub. Date: Jul. 10, 2014

(54) METHOD AND SYSTEM FOR MANAGING CACHE FILES

(71) Applicants: Chen-Li Kao, Taipei City (TW); Yu-Ting Lai, Taipei City (TW); Ko-Chun Lin, Taipei City (TW); Shih-Yi Chang, Taipei City (TW); Pei-Ching Hu, Taipei City (TW); Po-Chao Wang, Taipei City (TW); Ching-Tien Nien, Taipei City (TW); Yu-Hung Chen, Taipei City (TW); Chin-Hsun Wu, Taipei City (TW)

(72) Inventors: Chen-Li Kao, Taipei City (TW); Yu-Ting Lai, Taipei City (TW); Ko-Chun Lin, Taipei City (TW); Shih-Yi Chang, Taipei City (TW); Pei-Ching Hu, Taipei City (TW); Po-Chao Wang, Taipei City (TW); Ching-Tien Nien, Taipei City (TW); Yu-Hung Chen, Taipei City (TW); Chin-Hsun Wu, Taipei City (TW)

(73) Assignee: COMPAL ELECTRONICS, INC., Taipei City (TW)

(21) Appl. No.: 13/892,330

(22) Filed: May 13, 2013

(30) Foreign Application Priority Data
Jan. 8, 2013 (TW) 102100597

(51) Int. Cl. G06F 17/30

(52) U.S. Cl. CPC G06F 17/30115
USPC 707/694; 707/755; 707/722; 707/751

(57) ABSTRACT

A method and a system for managing cache files, adapted for a local end apparatus to manage files cached from a service end apparatus, are provided. In the method, a file is divided into a plurality of segments, and a part of the segments are downloaded from the service end apparatus and stored in the local end apparatus. Then, the segments of the file to be downloaded are increased or decreased according to a utility rate of the file.

### CROSS-REFERENCE TO RELATED APPLICATION

This application claims the priority benefit of Taiwan application serial no. 102100597, filed on Jan. 8, 2013. The entirety of the above-mentioned patent application is hereby incorporated by reference herein and made a part of this specification.

### BACKGROUND OF THE INVENTION

1. Field of the Invention

The present invention generally relates to a method and a system for managing files, in particular, to a method and a system for managing cache files according to a utility rate of a file.

2. Description of Related Art

For the convenience in file management and the saving in storage space at a local end, one of the preferred approaches is to store files altogether in a same device, which is accessible for a plurality of devices. Hence, there exists free or paid network storage space provided by many services so that users are able to upload files such as music, pictures, and videos to a network server. When such files are needed, the files may be downloaded via the network server and displayed or played at the local end.

As a network bandwidth increases, the download speed of multimedia files is able to catch up the playback speed. Thus, while a local end apparatus is downloading a file, the downloaded file may be played simultaneously so that an online video stream may be played in real-time. In such playback approach, a browser is adapted to connect to the uniform resource locator (URL) of a video stream, and an application program interface (API) at a lower layer such as DirectX is called via the browser to assist in decoding the downloaded video stream data in order to recover it back to a video file to be played at the local end.

Nonetheless, network traffic may occur since the network download speed is sometimes affected by factors such as the number of people on a network, the efficiency of a local end apparatus, or the efficiency of a network server. By using the online playback approach, a playback delay may occur due to network traffic and may further affect the user's viewing quality. Therefore, a better file download mechanism needs to be provided such that multimedia files possibly to be played by the user are prefetched so as to improve the playback efficiency of the multimedia files.

### SUMMARY OF THE INVENTION

Accordingly, the present invention is directed to a method and a system for managing cache files to save storage space at a local end and reduce time for downloading files from a service end.

The present invention is directed to a method for managing cache files, adapted to a local end apparatus managing a file cached from a service end apparatus. In the method, a file is divided into a plurality of segments, and a part of the segments are downloaded and stored from the service end apparatus. Then, the segments of the file to be downloaded are increased or decreased according to a utility rate of the file.

According to an embodiment of the present invention, the step of downloading and storing the part of the segments further includes downloading an original header file of the file from the service end apparatus and generating a new header file according to the downloaded original header file and the part of the segments. The new header file records a size of the file and a position and length information of the downloaded part of the segments with respect to the file.

According to an embodiment of the present invention, the step of downloading and storing the part of the segments further includes analyzing a type of the file so as to obtain necessary information required by the type of the file, and downloading and storing the necessary information.

According to an embodiment of the present invention, after the step of downloading and storing the part of the segments, the method further includes receiving a usage request for the file and accordingly accessing the stored part of the segments and downloading the other segments of the file so as to provide the file requested by the usage request.

According to an embodiment of the present invention, the step of increasing or decreasing the plurality of segments of the downloaded file according to the utility rate of the file includes calculating a cache weight for downloading the file according to the number of times of the file being accessed and a time length from a last accessed time point of the file until present, and accordingly increasing or decreasing the segments of the file to be downloaded.

According to an embodiment of the present invention, the step of calculating the cache weight for downloading the file according to the number of times of the file being accessed and the last accessed time point of the file until present includes accumulating the number of times of the file being accessed within a predetermined time and accordingly increasing the cache weight for downloading the file.

According to an embodiment of the present invention, the step of increasing or decreasing the plurality of segments of the file to be downloaded according to the utility rate of the file includes accumulating the number of times of the file being accessed within a predetermined time, accumulating the time length from the last accessed time point of the file until present and accordingly obtaining a weight adjustment value, and calculating a multiplication of the number of times and the weight adjustment value and using the multiplication as the cache weight for downloading the file.

According to an embodiment of the present invention, the step of downloading and storing the part of the segments further includes determining if cache space for storing the downloaded part of the segments is sufficient. If the cache space is not sufficient, a cache list of a plurality of files stored in the cache space is obtained. Then, the files are ordered according to the cache weight of each of the files and the files in a later portion are deleted for storing the downloaded part of the segments.

Furthermore, the present invention is directed to a system for managing cache files. The management system includes a download module and a cache module. The download module connects to a service end apparatus via a network so as to download and store a part of segments of a file. The cache module increases or decreases the plurality of segments of the file to be downloaded according to a utility rate of the file.

According to an embodiment of the present invention, the download module further downloads an original header file of the file from the service end apparatus. The cache module further generates a new header file according to the downloaded original header file and the part of the segments, wherein the new header file records a size of the file, a position and length information of the downloaded part of the segments with respect to the file.

According to an embodiment of the present invention, the cache module further analyzes a type of the file so as to obtain necessary information required by the type of the file, and downloads and stores the necessary information from the service end apparatus.

According to an embodiment of the present invention, the management system further includes a database module for storing the downloaded part of the segments in a database.

According to an embodiment of the present invention, the management system further includes a management module for receiving a usage request for the file, accordingly accessing the part of the segments stored in the database module, and downloading the other segments of the file from the service end apparatus by using the download module so as to provide the file requested from the usage request.

According to an embodiment of the present invention, the cache module further calculates a cache weight for downloading the file according to the number of times of the file being accessed and a last accessed time point of the file until present, and accordingly increases or decreases the segments of the file to be downloaded.

According to an embodiment of the present invention, the cache module further accumulates the number of times of the file being accessed within a predetermined time and accordingly increases the cache weight for downloading the file.

According to an embodiment of the present invention, the cache module further accumulates the number of times of the file being accessed within a predetermined time, accumulates the time length from the last accessed time point of the file until present, accordingly obtains a weight adjustment value, and calculates a multiplication of the number of times and the weight adjustment value and uses the multiplication as the cache weight for downloading the file.

According to an embodiment of the present invention, the download module further determines if cache space for storing the downloaded part of the segments is sufficient. If the cache space is not sufficient, the download module obtains a cache list of a plurality of files stored in the cache space, orders the files according to the cache weight of each of the files and deletes the files in a later portion for storing the downloaded part of the segments.

To sum up, in the method and the system for managing cache files of the present invention, a file is divided into a plurality of segments, and the number of the file segments to be preserved at a local end is determined by the number of times of the file being accessed and the time of the file not being accessed. Hence, storage space at the local end may be saved effectively, and the time for downloading files from a service end may be reduced.

Several exemplary embodiments accompanied with figures are described in detail below to further describe the disclosure in details.

### BRIEF DESCRIPTION OF THE DRAWINGS

FIG. 1 is a block diagram of a system for managing cache files according to an embodiment of the present invention.

FIG. 2 is a flowchart of a method for managing cache files according to an embodiment of the present invention.

FIG. 3 is an example of a cache file according to an embodiment of the present invention.

FIG. 4 is an example of a cache file according to an embodiment of the present invention.

FIG. 5 is a system for managing cache files according to an embodiment of the present invention.

FIG. 6 is a flowchart of a method for managing cache files according to an embodiment of the present invention.

FIG. 7(a) to FIG. 7(c) illustrate an example of a cache file according to an embodiment of the present invention.

### DESCRIPTION OF THE EMBODIMENTS

To save storage space in a local end apparatus as well as to prevent any file download or playback delay due to network traffic, a file stored in a service end apparatus is divided into a plurality of segments, and a part of the segments are pre-cached in the local end apparatus in the present invention so that the file data may be provided in real-time to respond to an access demand from the local end apparatus. Moreover, a cache weight of each file is calculated based on a utility rate thereof in the present invention, and the number of segments cached in the local end apparatus is accordingly adjusted so as to optimize managing cache files.

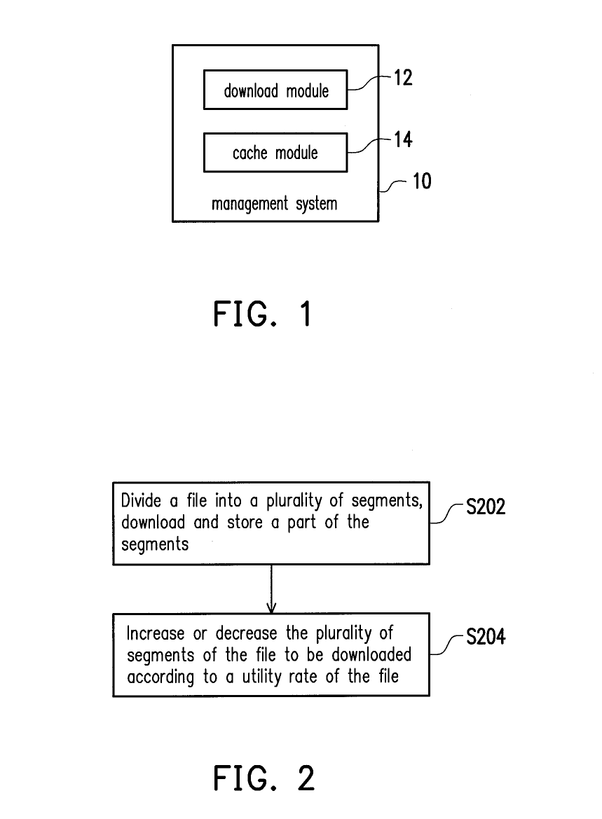

FIG. 1 is a block diagram of a system for managing cache files according to an embodiment of the present invention. Referring to FIG. 1, a management system 10 in the present embodiment is disposed in an electronic device such as a cellular phone, a smart phone, a personal digital assistant (PDA), a PDA cellular phone, a tabular computer, a laptop computer, or a desktop computer at a local end for managing file data cached by a local end apparatus. The management system 10 includes a download module 12 and a cache module 14. Such modules are, for example, hardware devices composed by logic circuit components for managing cache files or programs stored in a storage media at the local end apparatus loadable to a processor at the local end apparatus for managing cache files.

FIG. 2 is a flowchart of a method for managing cache files according to an embodiment of the present invention. Referring to both FIG. 1 and FIG. 2, the method in the present embodiment is adapted to the management system 10. Detailed steps of the method for managing cache files in the present embodiment will be illustrated along with each component of the management system 10 hereinafter.

First, the download module 12 connects to a service end apparatus via a network and divides a file stored in the service end apparatus into a plurality of segments so as to download and store a part of the segments (Step S202). To be specific, the download module 12 may, for example, connect to the service end apparatus on the network via a network interface card disposed in the local end apparatus so as to download a required file from the service end apparatus. The download module 12 may determine a segment size based on factors such as a size of cache space at the local end apparatus, a size of a downloaded file and a download bandwidth and divide the file into a plurality of segments based on the segment size so that a part of the segments may be prefetched based on requests.

It is noted that, while downloading the file segments, the download module 12 also simultaneously downloads an original header file so as to obtain related information of an original file. While the downloaded segments are being stored, the download module 12 may generate a new header file according to the original header file and the downloaded part of the segments. Such new header file may, for example, record a size of the file, position and length information of the downloaded part of the segments with respect to the original file so as to allow the local end apparatus to access the file.

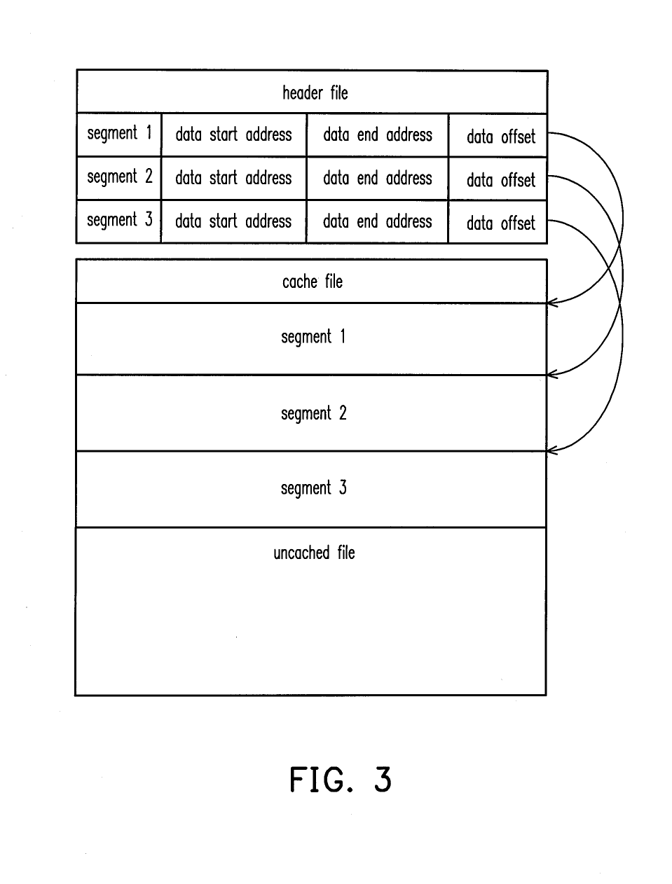

For example, FIG. 3 is an example of a cache file according to an embodiment of the present invention. Referring to FIG. 3, according to an order and a size of each downloaded segment, when a new header file is created, a position and a length of each of the segments with respect to an original file is recorded in the new header file in the present embodiment. For example, when the local end apparatus finishes downloading segments 1, 2, and 3, a data start address, a data end address, and a data offset of each of the segments 1, 2, and 3 with respect to a cache file are recorded in the header file. By that means, when the local end apparatus needs to access the file, the local end apparatus may obtain a data storing address of each of the segment data from the header file and further access the required file.

On the other hand, in terms of different types of files, methods for segmenting files and parsing header files are different. Also, for certain files, file contents may not be read properly until particular necessary information is read. Therefore, before downloading files, the download module 12 may, for example, first analyze a type of each of the files so that necessary information of such type of the files may be obtained. While downloading the segment data, the download module 12 also downloads the necessary information simultaneously to the local end apparatus.

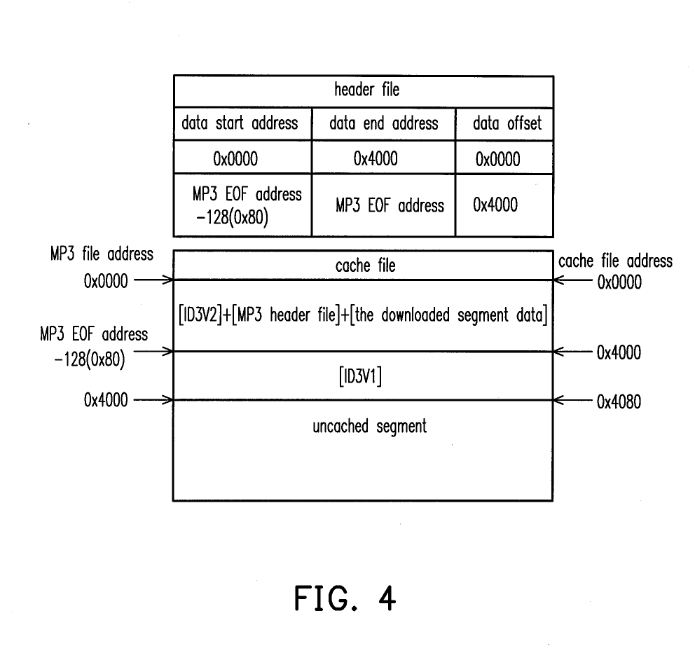

For example, FIG. 4 is an example of a cache file according to an embodiment of the present invention. Referring to FIG. 4, downloading MP3 files is taken as an example in the present embodiment. It is assumed that a MP3 file includes two pieces of necessary information ID3 V1 and ID3 V2. The ID3 V2 is data placed at the first 10 bytes plus a variable length from a start address of the file, wherein the data of variable length may be placed, for example, at the sixth to the tenth bytes from the start address of the file. On the other hand, ID3 V1 is fixedly placed at the last 128 bytes of the file. By that means, while downloading the file, the local end apparatus may first read necessary information at the aforementioned address, store a header file of the MP3 file and downloaded segment data in cache space at the local end. The local end apparatus may, for example, store the read ID3 V2, MP3 header file, and downloaded segment data to a location with a start address at 0x0000, an end address at 0x4000, and an offset of 0x0000; store the read ID3 V1 to a location with a start address at the last 128^{th} byte from the end of the file, an end address at the end of the file, and an offset of 0x4000; record the storing location of such data in the header file for usage in the future.

Referring back to FIG. 2, after the segment data is stored, the cache module 14 may increase or decrease the plurality of segments of the file to be downloaded according to a utility rate of the file (Step S204). The cache module 14 may, for example, calculate a cache weight of the downloaded file as well as accordingly increase or decrease the segments of the file to be downloaded based on the number of times of the file being accessed and the time length from the last accessed time of the file until present.

To be specific, in an embodiment, the cache module 14 may, for example, accumulate the number of times of the file being accessed in a predetermined time and accordingly increase the cache weight of the downloaded file. In other words, as the number of times of the file being accessed increases, it represents that the file is more frequently being used. To save the bandwidth occupied for repeatedly downloading the file, the cache module 14 may increase the cache weight of the file properly so as to store more segment data in the local end apparatus.

In another embodiment, besides accumulating the number of times of the file being accessed, the cache module 14 may accumulate the time length from the last accessed time of the file being stored until present, obtain a weight adjustment value accordingly, and calculate a multiplication of the number of times of the file being accessed and the weight adjustment value and use the multiplication as a cache weight for downloading the file. With respect to different time lengths, the cache module 14 may set a plurality of weight adjustment values with nonlinear relationship there between so as to drastically decrease cache weights of files not being accessed within a long period of time for saving the cache space.

For example, if a file has not been accessed in 24 hours, a weight adjustment value thereof may be set to 100. If a file has not been stored in 2 days, 3 days, or 4 days, weight adjustment values may be reduced to 10, 9, or 8 respectively so as to reduce cache weights drastically. Moreover, if a file has not been stored over 7 days, a weight adjustment value thereof may be set to 0 so as to make a cache weight be 0 and delete all data of the file from the local end apparatus. Therefore, the cache module 14 may obtain a cache weight reflecting a utility rate of a file after a weight adjustment value is multiplied by the number of times of the file being stored, and the cache module 14 may adjust a ratio of the file downloaded by the download module 12 for saving the cache space.

Through the mechanism of prefetching a part of segment data, the local end apparatus may provide file data based on user demands without occupying excessive cache space as well as reduce time for downloading files from the service end apparatus.

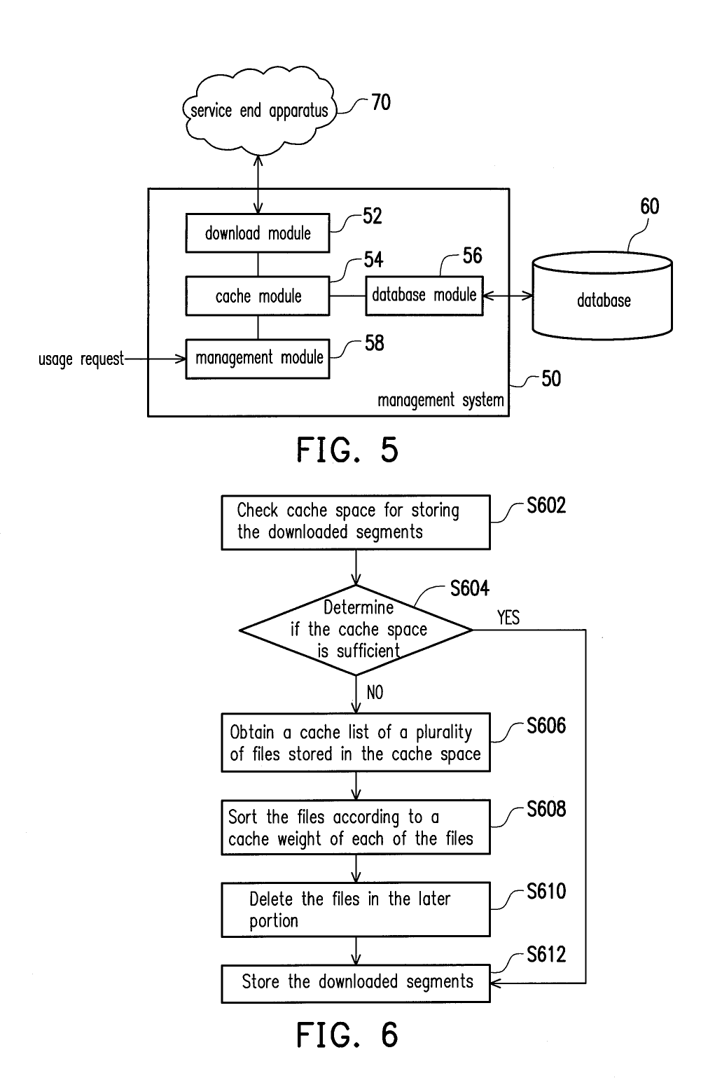

For example, FIG. 5 is a system for managing cache files according to an embodiment of the present invention. Referring to FIG. 5, a management system 50 includes a download module 52, a cache module 54, a database module 56 and a management module 58. Such modules are, for example, hardware devices composed by logic circuit components for managing cache files or programs stored in a storage media at the local end apparatus loadable to a processor at the local end apparatus for managing cache files. The download module 52 may, for example, connect to a service end apparatus 70 and download a part of segments of a file therefrom. The cache module 54 may increase or decrease the segments of the file to be downloaded according to a utility rate of the file. The functionality of the cache module 54 is the same as or similar to the download module 12 and the cache module 14 in the aforementioned embodiment and may not be repeated herein.

The difference from the aforementioned embodiment is that, in the present embodiment, the management system 50 further includes a database module 56, which may be used for connecting to a database 60 at the local end or in the local end apparatus itself and storing the downloaded segments from the download module 52 in the database 60. On the other hand, the management system 50 further includes the management module 58, which may receive a usage demand of the file from the local end apparatus and accordingly access the part of the segments stored in the database module 56 as well as download the other segments from the service end apparatus 70 by using the download module 52 and provide the file requested by the usage demand.

It is noted that, with the limited cache space, if a new file wishes to be stored in the local end apparatus, it may result in cache space insufficiency. Meanwhile, a part of the files in the local end apparatus are required to be deleted for storing the new file. Therefore, the cache weight of each of the files calculated from the aforementioned embodiment may be adapted for ordering the files stored in the cache space so as to find out and delete less frequently accessed files for storing the new file data in the present invention. Another embodiment will be described in details hereinafter.

FIG. 6 is a flowchart of a method for managing cache files according to an embodiment of the present invention. Referring to FIG. 1 and FIG. 6, the present embodiment is adapted for the management system 10. Detailed steps of the method for managing cache files will be described in the present embodiment along with each of the components in the management system 10 hereinafter.

First, before downloading a part of segments of the file, the download module 12 may first, for example, check cache space for storing the downloaded segments in the local end apparatus (Step S602) and determine if the cache space is sufficient for storing the downloaded segment data (Step S604). If the download module 12 determines that the cache space is sufficient, the download module 12 may store the downloaded segment data directly in the cache space (Step S612).

On the other hand, if the download module 12 determines that the cache insufficient, the download module 12 may obtain a cache list of a plurality of files stored in the cache space (Step S606). Then, the download module 12 may, for example, order the files according to a cache weight of each of the files (Step S608) and delete the files in the later portion (Step S610) so as to store the downloaded segment data in the vacant cache space. The cache weight of each of the files is, for example, calculated based on factors such as the number of times of each of the files being accessed and the time length from the last accessed time point of the file being stored until present. The detailed calculation method has been disclosed in the aforementioned embodiment and may not be repeated herein.

Through the aforementioned method, the local end apparatus may flexibly adjust the arrangement of the files in the cache space so as to optimize the management of the cache files.

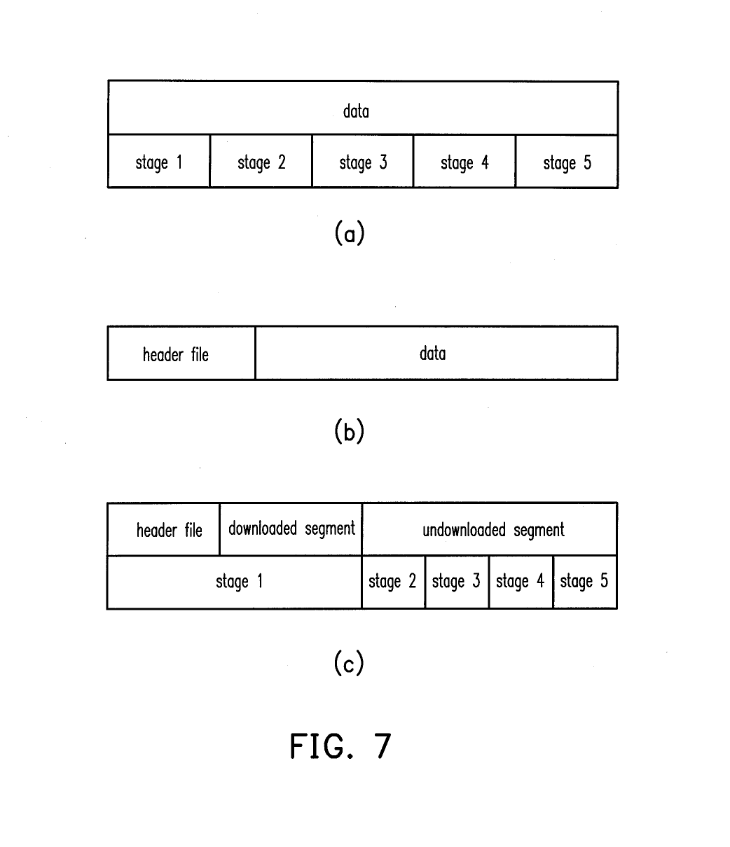

Moreover, in terms of the method for increasing or decreasing the segments to be downloaded, a plurality of stages are further defined in the present invention, wherein each of the stages corresponds to different number of segments so that the local end apparatus may determine the stage to use based on requirements. For example, FIG. 7(a) to FIG. 7(b) illustrate an example of a cache file according to an embodiment of the present invention. Referring to FIG. 7(a), in terms of a file with a unrecognized format, a plurality of segments of the file may be evenly distributed to a plurality of stages (e.g. stages 1-5) based on a size of the file so as to increase or decrease the segments to be downloaded that meet the storage requirement of the local end apparatus. Next, referring to FIG. 7(b) and FIG. 7(c), in terms of a file with a recognized format, a header file thereof and a part of the segments may correspond to the stage 1, and the remaining segments may be evenly distributed to the other stages (e.g. the stages 2-5) so as to increase or decrease the segments to be downloaded that meet the storage requirement of the local end apparatus.

To sum up, in the method and the system for managing cache files of the present invention, a file is divided into a plurality of segments, and a cache weight is calculated based on the number of times of the file being accessed within a period of time and the time of the file not being accessed. Hence, when a local end apparatus is downloading the file data, it may properly adjust a ratio for downloading the file data. Hence, cache space at a local end may be saved effectively, and the time for downloading files from a service end may be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for managing cache files, adapted to a local end apparatus managing a file cached from a service end apparatus, comprising:
dividing the file into a plurality of segments, downloading and storing a part of the segments; and
increasing or decreasing the plurality of segments of the file to be downloaded according to a utility rate of the file.

2. The method for managing cache files of claim 1, wherein the step of downloading and storing the part of the segments further comprises:
downloading an original header file of the file.

3. The method for managing cache files of claim 2, wherein the step of downloading and storing the part of the segments further comprises:
generating a new header file according to the downloaded original header file and the part of the segments, wherein the new header file records a size of the file and a position and length information of the downloaded part of the segments with respect to the file.

4. The method for managing cache files of claim 1, wherein the step of downloading and storing the part of the segments further comprises:
analyzing a type of the file so as to obtain necessary information required by the type of the file; and
downloading and storing the necessary information.

5. The method for managing cache files of claim 1, wherein after the step of downloading and storing the part of the segments, the method further comprises:
receiving a usage request for the file; and
accessing the stored part of the segments and downloading the other segments of the file so as to provide the file requested by the usage request.

6. The method for managing cache files of claim 1, wherein the step of increasing or decreasing the plurality of segments of the downloaded file according to the utility rate of the file comprises:
calculating a cache weight for downloading the file according to the number of times of the file being accessed and a time length from a last accessed time point of the file until present, and accordingly increasing or decreasing the segments of the file to be downloaded according to the cache weight.

7. The method for managing cache files of claim 6, wherein the step of calculating the cache weight for downloading the file according to the number of times of the file being accessed and the time length from the time point of the file last accessed until present comprises:
accumulating the number of times of the file being accessed within a predetermined time and accordingly increasing the cache weight for downloading the file.

8. The method for managing cache files of claim 6, wherein the step of increasing or decreasing the plurality of segments of the file to be downloaded according to the utility rate of the file comprises:
accumulating the number of times of the file being accessed within a predetermined time;
accumulating the time length from the last accessed time point of the file until present and accordingly obtaining a weight adjustment value; and
calculating a multiplication of the number of times and the weight adjustment value and using the multiplication as the cache weight for downloading the file.

9. The method for managing cache files of claim 6, wherein the step of downloading and storing the part of the segments further comprises:
determining if cache space for storing the downloaded part of the segments is sufficient;
obtaining a cache list of a plurality of files stored in the cache space if the cache space is not sufficient; and
ordering the files according to the cache weight of each of the files and deleting a part of the files ordered at a bottom for storing the downloaded part of the segments.

10. A system for managing cache files comprising:
a download module, configured to connect to a service end apparatus via a network so as to download and store a part of segments of a file; and
a cache module, configured to increase or decrease the plurality of segments of the file to be downloaded according to a utility rate of the file.

11. The system for managing cache files of claim 10, wherein the download module further downloads an original header file of the file from the service end apparatus.

12. The system for managing cache files of claim 11, wherein the cache module further generates a new header file according to the downloaded original header file and the part of the segments, wherein the new header file records a size of the file, a position and length information of the downloaded part of the segments with respect to the file.

13. The system for managing cache files of claim 10, wherein the download module further analyzes a type of the file so as to obtain necessary information required by the type of the file, and downloads and stores the necessary information from the service end apparatus.

14. The system for managing cache files of claim 10 further comprising:
a database module, configured to store the downloaded part of the segments in a database.

15. The system for managing cache files of claim 14 further comprising:
a management module, configured to receive a usage request for the file, accordingly access the part of the segments stored in the database module, and download the other segments of the file from the service end apparatus by using the download module so as to provide the file requested by the usage request.

16. The system for managing cache files of claim 10, wherein the cache module further calculates a cache weight for downloading the file according to the number of times of the file being accessed and a time length from a last accessed time point of the file until present, and accordingly increases or decreases the segments of the file to be downloaded according to the cache weight.

17. The system for managing cache files of claim 16, wherein the cache module further accumulates the number of times of the file being accessed within a predetermined time and accordingly increases the cache weight for downloading the file.

18. The system for managing cache files of claim 16, wherein the cache module further accumulates the number of times of the file being accessed within a predetermined time, accumulates the time length from the last accessed time point of the file until present and accordingly obtains a weight adjustment value, and calculates a multiplication of the number of times and the weight adjustment value and uses the multiplication as the cache weight for downloading the file.

19. The system for managing cache files of claim 16, wherein the download modules further determines if cache space for storing the downloaded part of the segments is sufficient, obtains a cache list of a plurality of files stored in the cache space if the cache space is not sufficient, orders the files according to the cache weight of each of the files and deletes the files in a later portion for storing the downloaded part of the segments.
